(19) United States
(12) Patent Application Publication
(10) Pub. No.: US 2012/0068487 A1
(43) Pub. Date: Mar. 22, 2012

(54) Collapsible chopsticks with integrated case, clip, and stand

(76) Inventor: Alison Wong, Menlo Park, CA (US)

(21) Appl. No.: 13/200,128

(22) Filed: Sep. 19, 2011

Related U.S. Application Data
(60) Provisional application No. 61/403,747, filed on Sep. 21, 2010.

(51) Int. Cl. A47G 21/00; F16B 2/20

(52) U.S. Cl. 294/218; 24/570

(57) ABSTRACT

A collapsible chopstick includes a food-contact element and a hollow handle element having an open end. The food contact element is tapered and includes a securing section that is sized to create a press fit with the hollow open end of the handle so that the food-contact element and handle can be connected together with the food-contact element exposed for using the chopsticks for eating or with the food-contact element safely secured within the hollow handle for stowing. A resilient connector/support block is included with two side channels and a curved top surface. The channels are sized to snugly receive and hold the two handles parallel to each other for convenient stowing and carrying and may be used separately to effectively hold the tips of the chopsticks off an eating surface when in use.

### CROSS-REFERENCE TO RELATED APPLICATIONS

This application is based on and claims the benefit of priority from Provisional Patent application, Ser. No. 61/403,747, filed Sep. 21, 2010, the entire contents of which are incorporated herein by reference.

### BACKGROUND OF THE INVENTION

a) Field of the Invention

This invention generally relates to eating utensils of the type that include features that benefit storage and ease of use, and more particularly, to collapsible chopsticks that include such features.

b) Description of the Prior Art

Utensils for eating have been around almost as long as, well, eating. Hundreds of features to these basic tools have been developed over the years to help people eat more efficiently and more comfortably. The use of new materials is a common practice in this industry, as well as providing features of convenience for storage and use.

Chopsticks are one of the most widely used utensils in the world. This simple elegant device is used at least three times a day by upwards of 2 billion people in various cultures. Chopsticks are used in pairs and although are typically made from simple available organic materials, such as bamboo or soft woods, they are also made from other harder woods, plastics, bone, ivory, metal, porcelain, ceramic, glass, and likely other materials as well. Each chopstick is made from an elongated shaft of definite length (usually about 8 to 10 inches long) of a material having uniform section that usually extends undisturbed a short distance to define a gripping handle section and then usually continues with a graceful shallow taper extending the remaining length of the member to a tip that defines the food-contact section.

The chopsticks are used in pairs and manipulated by the fingers of one hand to grasp the food and to carry the food from a dish to the mouth of the consumer. When chopsticks are laid down to rest, the tips can become unsanitary, which is why many Asian cultures use chopstick stands as a necessary complement to chopsticks.

Although some chopsticks are made using different materials for the handle section and food-contact section and many include ornate designs, the vast majority of chopsticks used each and everyday throughout the world are disposable chopsticks. These disposable cheap versions are made for low cost, quick and easy use, easy distribution and sadly just as quickly thrown away after the meal is done—they are rarely reused. Made largely from birch, poplar, and bamboo, disposable chopsticks are thrown away at about 45 billion pairs a year. (130 million pairs of chopsticks a day.) Greenpeace China has estimated that to keep up with this demand, 100 acres of trees need to be felled every 24 hours.

Therefore, a long-standing need has existed to provide a pair of chopsticks wherein each stick can be dissembled into separate parts and carried easily together for transport from one place to another in a sanitary fashion. Making the chopsticks more easily portable also helps reduce waste because of their reuse. Reusing chopsticks helps mitigate vast deforestation, landfill overflow, and gives consumers a sustainable option. Also, even though some restaurants provide reusable chopsticks in their restaurants, they may not have been properly sanitized.

Regardless of the reason, collapsible chopsticks have become commercially available with varying commercial success. One such version is shown in U.S. Pat. No. of 7,093,868 wherein a chopstick is disclosed having a handle section and food-contact section that collapses into the handle section. This telescoping design allows for a compact form for portability, but needs a separate case to keep the chopsticks enclosed.

Another collapsible chopstick is disclosed in U.S. Pat. No. of 6,328,360 wherein the chopstick includes separable sections and wherein the handle section and the food-contact section press fit into each other. Yet, when separate, the sections do not act as casings so they must be transported as four separate pieces in a separate case.

Other portable chopsticks require too much effort and time to assemble, as some require screwing together, or removing from a case. The more complicated the design is, the more parts there are, and the more time it takes assemble hinders using portable chopsticks. This results in people forgetting to bring them or thinking they are too much hassle and thus default to using the disposable chopsticks given.

### SUMMARY OF THE INVENTION

A collapsible chopstick includes a food-contact element and a hollow handle element having an open end. The food contact element is tapered and includes a securing section that is sized to create a press fit with the hollow open end of the handle so that the food-contact element and handle can be connected together with the food-contact element exposed for using the chopsticks for eating or with the food-contact element safely secured within the hollow handle for stowing. A resilient connector/support block is included with two side channels and a curved top surface. The channels are sized to snugly receive and hold the two handles parallel to each other for convenient stowing and carrying and may be used separately to effectively hold the tips of the chopsticks off an eating surface when in use.

### BRIEF DESCRIPTION OF THE FIGURES

FIG. 1 is a perspective view of the chopstick assembly showing a pair of collapsible chopsticks in a usable position and resting on a connector/rest, according to the invention;

FIG. 2 is a perspective view of the chopstick assembly showing the decoupling or assembly of the two separate parts of one chopstick, according to the invention;

FIG. 3 is a perspective view of the chopstick wherein a food-contact element is positioned to be inserted into (or removed from) a hollow handle section, according to the invention;

FIG. 4 shows the two chopsticks in a collapsed state being connected to a connector/support block, according to the invention;

FIG. 5 is a perspective view of the chopstick assembly in its portable state, with both collapsed chopsticks tightly held within the connector/support block; and

FIG. 6 is a perspective view of the chopstick assembly according to a second embodiment wherein the food-contact element includes a deformable elastomeric end.

### DETAILED DESCRIPTION OF THE FIGURES

An important purpose of the present invention is to provide a pair of chopsticks that can be easily collapsed for effective and efficient storage and easily assembled for use. When collapsed, the chopsticks can be conveniently secured to each other using a connector that serves as an efficient and effective support for temporarily supporting the tips of the assembled chopsticks when not in use.

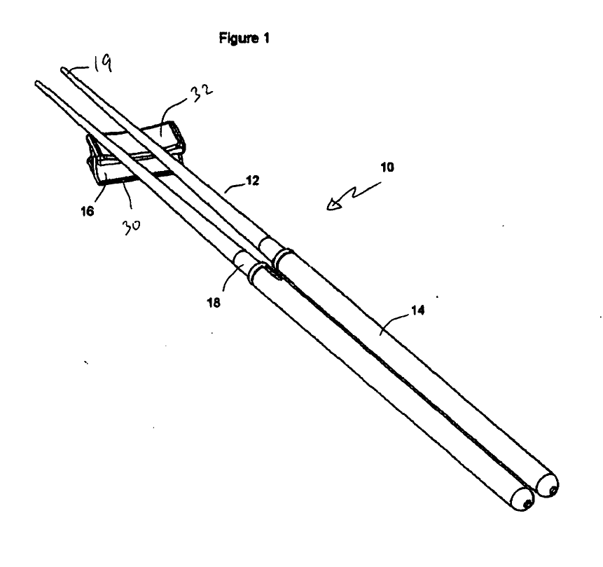

Referring to FIG. 1, a pair of chopsticks 10 is shown including a food-contact element 12, a handle 14 and a connector/support block 16. The two chopsticks are shown assembled and supported on the connector/support block, according to the present invention. As explained in greater detail below, handle 14 is designed to both selectively house element 12 when the chopsticks are being stowed, and effectively hold a portion of element 12 when the chopsticks are being used for eating.

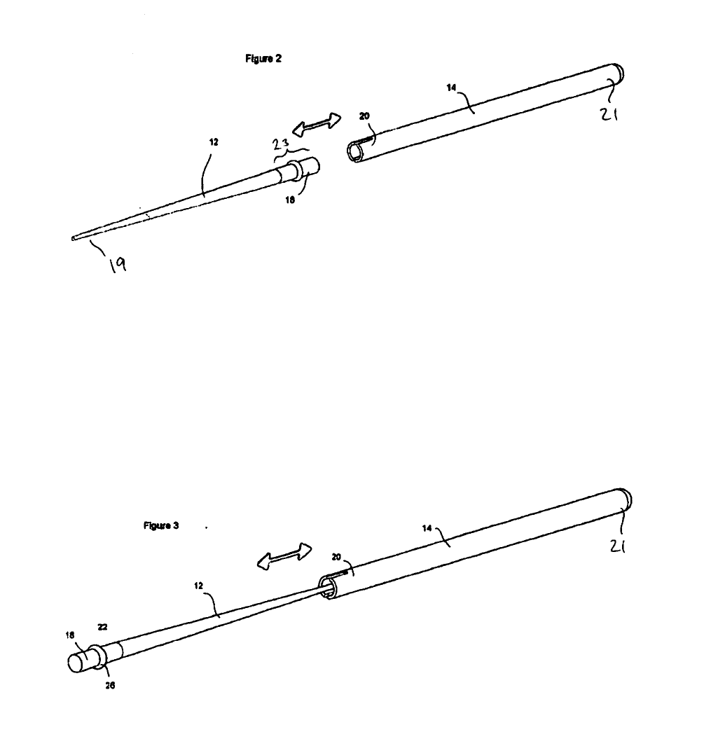

Food-contact element 12 is preferably made from an appropriate natural material, such as a bamboo wood, but can be made from any of a variety of materials, including soft and hard woods, plastic, metal, and bone (really any material can be used as long as the material is suitable as a food-contact material and can be easily cleaned on a regular basis). The material preferably is finished with a very smooth surface having very small, or effectively no surface interstices into which bacterial can reside and thrive. Referring to FIGS. 2 and 3, element 12 includes a connecting end 18 having a large diameter and an opposing tip 19 having a small diameter (preferably blunt). Element 12 is preferably shaped with a gradual taper from large diameter connecting end 18 to tip 19. Connecting end 18 includes a securing section 23 that has a uniform diameter. Securing section 23 is preferably about ½ inch long and includes an intermediate stop flange 26 which functions as a stop, as described below.

As shown in FIGS. 2 and 3, handle 14 is hollow and includes a connecting end 20 and an opposing end 21. Handle 14 is preferably made from an appropriate metal that is food safe, such as stainless steel. As shown in FIGS. 1 and 5, opposing end 21 is preferably rounded closed with a small opening 38 for allowing the interior of handle 14 to dry after washing and also allowing air to pass to equilibrate a pressure change that will likely occur when element 12 is inserted into and removed from handle 14, as explained below. Handle 14 is sized and shaped to selectively receive element 12 when the chopsticks are stowed.

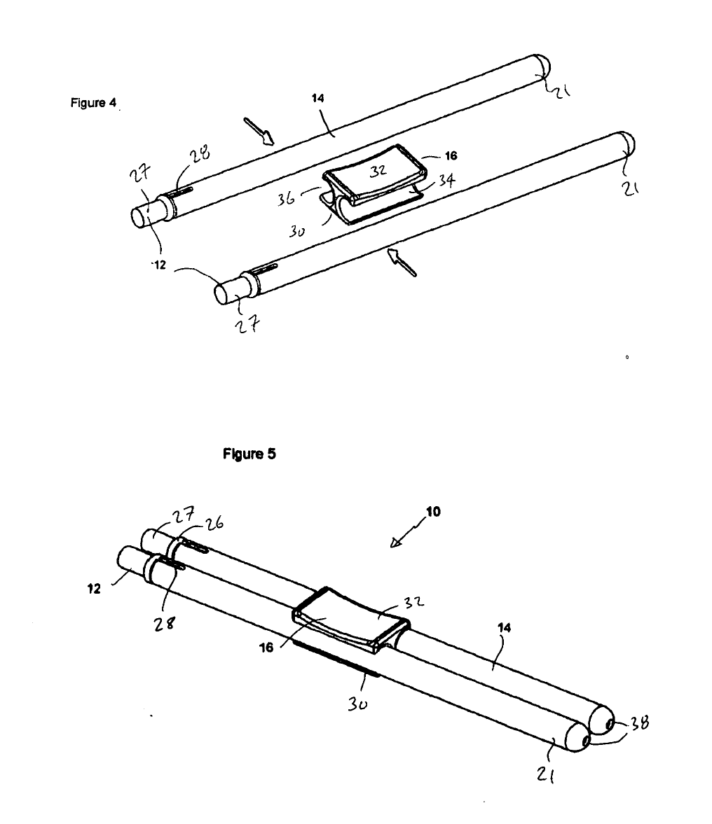

Connecting end 20 of handle 14 is sized and shaped to selectively and snugly receive connecting end 18 of element 12 when element 12 is inserted into handle 14 either for use for eating, as shown in FIG. 2, or for storage, as shown in FIG. 3. To help control the distance that connecting end 18 of element 12 can be inserted into handle 14, stop flange 26 is preferably positioned at a midpoint along securing section of uniform diameter. Stop flange 26 will abut the edges of connecting end 20 of handle 14 when element 12 is secured to handle 14 for either eating, as shown in FIG. 1, or stowing, as shown in FIGS. 4 and 5.

As can be appreciated by those skilled in the art, slots 28 are provided in handle 14 a predescribed distance and preferably parallel to the longitudinal axis of the handle. Slots 28 are provided to allow the handles to establish an interference fit with connecting end 18 of element 12. The slots will allow a kind of friction fit against the surface of element 12 which holds well during use, but can be relatively easily overcome by the user when separation is desired.

In use, as shown in FIG. 2, element 12 is positioned with connecting end 18 aligned with and adjacent to connecting end 20 of handle 14. Securing region 23 is then pressed into handle 14 against the spring action of the handle created by slots 28 until flange 26 abuts against handle 14. The chopstick can now be used for eating or poking at people.

When it is desired to collapse the chopstick 10, the user merely has to grip handle 14 and element 12 and pull the two apart. After cleaning, element 12 can be positioned so that tip 19 is aligned with the hollow opening of handle 14 and inserted the full length into the handle. Eventually, the tapered element 12 will give rise to the securing region of uniform large diameter contacting the inside walls of handle 14 with a friction fit until stop flange 26 reaches and abuts the edge of handle 14. This action is shown in FIG. 3 with the element fully inserted shown in FIG. 4. As shown in FIG. 4, a short portion 27 of connecting 18 of element 12 remains exposed outside handle 14 so that the user may grip this portion 27 to help extract element 12 from handle 14 when desired.

As shown in FIGS. 1, 4 and 5, a connector/support block 16 is shown which is preferably made from a semi-rigid material having some resiliency, such as a medium durometer rubber or flexible plastic. The block 16 includes a flat bottom 30, an inwardly curved or cupped top 32 and two C-shaped channels 34. Each channel includes a side opening 36 that allows receipt of handle 14 and is sized and shaped to hold a received handle with a resounding snap-fit. The snap fit will hold inserted handles in place and hold them together in a convenient manner for stowing and carrying but can also be easily overcome by the user to remove the handles from the grip of the block 16. Once the handles are removed, a shown in FIG. 1, block 16 can be positioned with flat bottom 30 on a table surface so that cupped top 32 can be used to effectively hold tips 19 of chopsticks 10 in between bites.

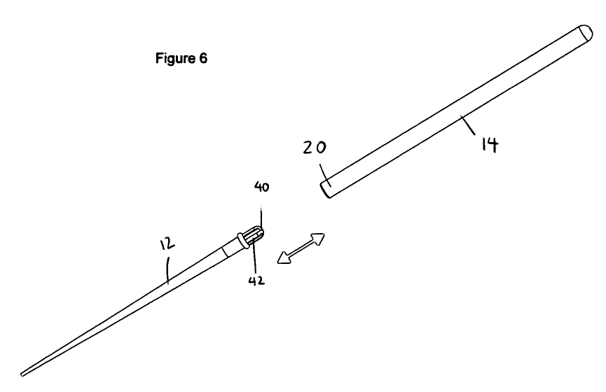

Referring to FIG. 6, another embodiment of the invention is shown wherein connecting end 18 of element 12 includes an over-molded rubber element 40 (or other elastomeric material) that is sized and shaped to snugly fit into connecting end 20 of handle 14. The durometer of the rubber element 40 may be selected depending on the size and shape as one of ordinary skill in the art would understand. However, a durometer between 35 and 70 is preferred. According to this embodiment, connecting end 20 of handle 14 does not require slots 28 because when connecting end 18 is inserted into connecting end 20, rubber element 40 will compress and provide a tight fit, as is well understood by those skilled in the art.

Rubber element 40 may include integrally formed ribs 42 to help provide a snug fit and easy insertion into connecting end 20 of handle 14. Ribs 42 may be concentric, as shown, spiral, or straight parallel to the longitudinal axis of element 12.

a) Field of the Invention

This invention generally relates to eating utensils of the type that include features that benefit storage and ease of use, and more particularly, to collapsible chopsticks that include such features.

b) Description of the Prior Art

Utensils for eating have been around almost as long as, well, eating. Hundreds of features to these basic tools have been developed over the years to help people eat more efficiently and more comfortably. The use of new materials is a common practice in this industry, as well as providing features of convenience for storage and use.

Chopsticks are one of the most widely used utensils in the world. This simple elegant device is used at least three times a day by upwards of 2 billion people in various cultures. Chopsticks are used in pairs and although are typically made from simple available organic materials, such as bamboo or soft woods, they are also made from other harder woods, plastics, bone, ivory, metal, porcelain, ceramic, glass, and likely other materials as well. Each chopstick is made from an elongated shaft of definite length (usually about 8 to 10 inches long) of a material having uniform section that usually extends undisturbed a short distance to define a gripping handle section and then usually continues with a graceful shallow taper extending the remaining length of the member to a tip that defines the food-contact section.

The chopsticks are used in pairs and manipulated by the fingers of one hand to grasp the food and to carry the food from a dish to the mouth of the consumer. When chopsticks are laid down to rest, the tips can become unsanitary, which is why many Asian cultures use chopstick stands as a necessary complement to chopsticks.

Although some chopsticks are made using different materials for the handle section and food-contact section and many include ornate designs, the vast majority of chopsticks used each and everyday throughout the world are disposable chopsticks. These disposable cheap versions are made for low cost, quick and easy use, easy distribution and sadly just as quickly thrown away after the meal is done—they are rarely reused. Made largely from birch, poplar, and bamboo, disposable chopsticks are thrown away at about 45 billion pairs a year. (130 million pairs of chopsticks a day.) Greenpeace China has estimated that to keep up with this demand, 100 acres of trees need to be felled every 24 hours.

Therefore, a long-standing need has existed to provide a pair of chopsticks wherein each stick can be dissembled into separate parts and carried easily together for transport from one place to another in a sanitary fashion. Making the chopsticks more easily portable also helps reduce waste because of their reuse. Reusing chopsticks helps mitigate vast deforestation, landfill overflow, and gives consumers a sustainable option. Also, even though some restaurants provide reusable chopsticks in their restaurants, they may not have been properly sanitized.

Regardless of the reason, collapsible chopsticks have become commercially available with varying commercial success. One such version is shown in U.S. Pat. No. of 7,093,868 wherein a chopstick is disclosed having a handle section and food-contact section that collapses into the handle section. This telescoping design allows for a compact form for portability, but needs a separate case to keep the chopsticks enclosed.

Another collapsible chopstick is disclosed in U.S. Pat. No. of 6,328,360 wherein the chopstick includes separable sections and wherein the handle section and the food-contact section press fit into each other. Yet, when separate, the sections do not act as casings so they must be transported as four separate pieces in a separate case.

Other portable chopsticks require too much effort and time to assemble, as some require screwing together, or removing from a case. The more complicated the design is, the more parts there are, and the more time it takes assemble hinders using portable chopsticks. This results in people forgetting to bring them or thinking they are too much hassle and thus default to using the disposable chopsticks given.

### SUMMARY OF THE INVENTION

A collapsible chopstick includes a food-contact element and a hollow handle element having an open end. The food contact element is tapered and includes a securing section that is sized to create a press fit with the hollow open end of the handle so that the food-contact element and handle can be connected together with the food-contact element exposed for using the chopsticks for eating or with the food-contact element safely secured within the hollow handle for stowing. A resilient connector/support block is included with two side channels and a curved top surface. The channels are sized to snugly receive and hold the two handles parallel to each other for convenient stowing and carrying and may be used separately to effectively hold the tips of the chopsticks off an eating surface when in use.

### BRIEF DESCRIPTION OF THE FIGURES

FIG. 1 is a perspective view of the chopstick assembly showing a pair of collapsible chopsticks in a usable position and resting on a connector/rest, according to the invention;

FIG. 2 is a perspective view of the chopstick assembly showing the decoupling or assembly of the two separate parts of one chopstick, according to the invention;

FIG. 3 is a perspective view of the chopstick wherein a food-contact element is positioned to be inserted into (or removed from) a hollow handle section, according to the invention;

FIG. 4 shows the two chopsticks in a collapsed state being connected to a connector/support block, according to the invention;

FIG. 5 is a perspective view of the chopstick assembly in its portable state, with both collapsed chopsticks tightly held within the connector/support block; and

FIG. 6 is a perspective view of the chopstick assembly according to a second embodiment wherein the food-contact element includes a deformable elastomeric end.

### DETAILED DESCRIPTION OF THE FIGURES

An important purpose of the present invention is to provide a pair of chopsticks that can be easily collapsed for effective and efficient storage and easily assembled for use. When collapsed, the chopsticks can be conveniently secured to each other using a connector that serves as an efficient and effective support for temporarily supporting the tips of the assembled chopsticks when not in use.

Referring to FIG. 1, a pair of chopsticks 10 is shown including a food-contact element 12, a handle 14 and a connector/support block 16. The two chopsticks are shown assembled and supported on the connector/support block, according to the present invention. As explained in greater detail below, handle 14 is designed to both selectively house element 12 when the chopsticks are being stowed, and effectively hold a portion of element 12 when the chopsticks are being used for eating.

Food-contact element 12 is preferably made from an appropriate natural material, such as a bamboo wood, but can be made from any of a variety of materials, including soft and hard woods, plastic, metal, and bone (really any material can be used as long as the material is suitable as a food-contact material and can be easily cleaned on a regular basis). The material preferably is finished with a very smooth surface having very small, or effectively no surface interstices into which bacterial can reside and thrive. Referring to FIGS. 2 and 3, element 12 includes a connecting end 18 having a large diameter and an opposing tip 19 having a small diameter (preferably blunt). Element 12 is preferably shaped with a gradual taper from large diameter connecting end 18 to tip 19. Connecting end 18 includes a securing section 23 that has a uniform diameter. Securing section 23 is preferably about ½ inch long and includes an intermediate stop flange 26 which functions as a stop, as described below.

As shown in FIGS. 2 and 3, handle 14 is hollow and includes a connecting end 20 and an opposing end 21. Handle 14 is preferably made from an appropriate metal that is food safe, such as stainless steel. As shown in FIGS. 1 and 5, opposing end 21 is preferably rounded closed with a small opening 38 for allowing the interior of handle 14 to dry after washing and also allowing air to pass to equilibrate a pressure change that will likely occur when element 12 is inserted into and removed from handle 14, as explained below. Handle 14 is sized and shaped to selectively receive element 12 when the chopsticks are stowed.

Connecting end 20 of handle 14 is sized and shaped to selectively and snugly receive connecting end 18 of element 12 when element 12 is inserted into handle 14 either for use for eating, as shown in FIG. 2, or for storage, as shown in FIG. 3. To help control the distance that connecting end 18 of element 12 can be inserted into handle 14, stop flange 26 is preferably positioned at a midpoint along securing section of uniform diameter. Stop flange 26 will abut the edges of connecting end 20 of handle 14 when element 12 is secured to handle 14 for either eating, as shown in FIG. 1, or stowing, as shown in FIGS. 4 and 5.

As can be appreciated by those skilled in the art, slots 28 are provided in handle 14 a predescribed distance and preferably parallel to the longitudinal axis of the handle. Slots 28 are provided to allow the handles to establish an interference fit with connecting end 18 of element 12. The slots will allow a kind of friction fit against the surface of element 12 which holds well during use, but can be relatively easily overcome by the user when separation is desired.

In use, as shown in FIG. 2, element 12 is positioned with connecting end 18 aligned with and adjacent to connecting end 20 of handle 14. Securing region 23 is then pressed into handle 14 against the spring action of the handle created by slots 28 until flange 26 abuts against handle 14. The chopstick can now be used for eating or poking at people.

When it is desired to collapse the chopstick 10, the user merely has to grip handle 14 and element 12 and pull the two apart. After cleaning, element 12 can be positioned so that tip 19 is aligned with the hollow opening of handle 14 and inserted the full length into the handle. Eventually, the tapered element 12 will give rise to the securing region of uniform large diameter contacting the inside walls of handle 14 with a friction fit until stop flange 26 reaches and abuts the edge of handle 14. This action is shown in FIG. 3 with the element fully inserted shown in FIG. 4. As shown in FIG. 4, a short portion 27 of connecting 18 of element 12 remains exposed outside handle 14 so that the user may grip this portion 27 to help extract element 12 from handle 14 when desired.

As shown in FIGS. 1, 4 and 5, a connector/support block 16 is shown which is preferably made from a semi-rigid material having some resiliency, such as a medium durometer rubber or flexible plastic. The block 16 includes a flat bottom 30, an inwardly curved or cupped top 32 and two C-shaped channels 34. Each channel includes a side opening 36 that allows receipt of handle 14 and is sized and shaped to hold a received handle with a resounding snap-fit. The snap fit will hold inserted handles in place and hold them together in a convenient manner for stowing and carrying but can also be easily overcome by the user to remove the handles from the grip of the block 16. Once the handles are removed, a shown in FIG. 1, block 16 can be positioned with flat bottom 30 on a table surface so that cupped top 32 can be used to effectively hold tips 19 of chopsticks 10 in between bites.

Referring to FIG. 6, another embodiment of the invention is shown wherein connecting end 18 of element 12 includes an over-molded rubber element 40 (or other elastomeric material) that is sized and shaped to snugly fit into connecting end 20 of handle 14. The durometer of the rubber element 40 may be selected depending on the size and shape as one of ordinary skill in the art would understand. However, a durometer between 35 and 70 is preferred. According to this embodiment, connecting end 20 of handle 14 does not require slots 28 because when connecting end 18 is inserted into connecting end 20, rubber element 40 will compress and provide a tight fit, as is well understood by those skilled in the art.

Rubber element 40 may include integrally formed ribs 42 to help provide a snug fit and easy insertion into connecting end 20 of handle 14. Ribs 42 may be concentric, as shown, spiral, or straight parallel to the longitudinal axis of element 12.

What is claimed is:

1. A clip holder for selectively securing a pair of chopsticks together during storage, each of said chopsticks being of the type that includes a body for holding the chopstick and a usable tip for contacting food, said clip holder comprising:
a first C-shaped channel sized and shaped to selectively snugly receive a first chopstick of said pair of chopsticks in a stowed position;
a second C-shaped channel sized and shaped to selectively snugly receive a second chopstick of said pair of chopsticks in a stowed position; and
a concave curved surface onto which said tip portion of at least said first chopstick may be selectively cradled during chopstick use.

2. A collapsible chopstick including;
a handle section having a first hollow connecting end;
an eating section having a food-contacting tip at one end and an opposing second connecting end that is sized and shaped to selectively and snugly fit within said first hollow end; said construction of said chopstick allowing a user to selectively detach and connect said handle from said eating section between a usable position wherein said second connecting end of said eating section is snugly positioned within said first hollow connecting end of said handle and a stowed position wherein said eating section is separate from said handle.

3. The collapsible chopstick according to claim 2, wherein said handle section is hollow and sized and shaped to receive said eating section so that said food-contacting tip is enclosed and protected within said handle section.

4. The collapsible chopstick according to claim 2, wherein said first hollow connecting end of said handle section includes at least one elongated slot, said slot allows said hollow connecting end to expand slightly as it receives said second connecting end and thereby firmly grip onto said second connecting end.

5. The collapsible chopstick according to claim 2, wherein said second connecting end includes a deformable elastomeric element that is sized and shaped to selectively and snugly fit within said first hollow connecting end.

6. The collapsible chopstick according to claim 3, wherein said first hollow connecting end of said handle section includes at least one elongated slot, said slot allows said hollow connecting end to expand slightly as it receives said second connecting end and thereby firmly grip onto said second connecting end.

7. The collapsible chopstick according to claim 3, wherein said second connecting end includes a deformable elastomeric element that is sized and shaped to selectively and snugly fit within said first hollow connecting end.
